(19) United States
(12) Patent Application Publication
(10) Pub. No.: US 2010/0333132 A1
(43) Pub. Date: Dec. 30, 2010

(54) METHODS AND SYSTEMS FOR INDEXING ON-DEMAND VIDEO CONTENT IN A CABLE SYSTEM

(75) Inventors: Mark William Robertson, Lawrenceville, GA (US); William Corey Brown, Cumming, GA (US); David Crick, Hoschton, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television Inc.

(21) Appl. No.: 12/490,697

(22) Filed: Jun. 24, 2009

(51) Int. Cl. H04N 7/025; H04N 7/173

(52) U.S. Cl. 725/32; 725/89

(57) ABSTRACT

In one embodiment, an index is created by a first user for a specified video program that is applied when a second user request viewing the specified video program. The index is typically embodied by a file, which identifies one or more content segments of the video program that are not presented to the viewing user. The viewing user selects the program for viewing, typically using a video on-demand service offered by a cable service provider, and potentially indicates the index file to be applied when viewing the program. The cable service provider streams the video program to the user, but excises the one or more content segments identified in the index file, thus providing a customized viewing experience to the viewing user.

### FIELD OF INVENTION

In one embodiment, the present invention pertains to creating and/or using a custom index that creates a customized viewing experience by modifying the content of one or more on-demand video programs presented to a viewer in a cable system.

### BACKGROUND OF THE INVENTION

Cable service providers (“CSPs”) typically provide numerous channels providing a variety of programming to viewers. These programs include on-demand programs that a viewer can elect to view at their convenience including programming of certain types (e.g., sports, movies, etc.). Historically, the viewing experience of the program provided to the viewer was static or was determined by the service provider or program originator. By “viewing experience”, this means the content from the video program that was presented to the viewer. In other words, viewers were able to view a cable program as presented by the cable provider. While in some instances, the CSP provided the program with added advertisements, the service provider did not edit or skip any of the program content itself. Thus, each viewer was only able to view the entirety of the program as presented by the service provider.

The advent of digital video recording devices (such as DVRs) allowed viewers to alter their viewing experience by defining which programs are recorded and subsequently viewed. To a limited extent, viewers could fast forward and skip over certain sections of a program, presuming they had a DVR or other device capable of doing so. This was accomplished by the viewer invoking various viewing functions, such as “pause”, “play”, “fast forward”, which are sometimes called “trick functions” in the industry.

However, many video service providers provide the service of allowing the user to select the video program and have it presented to them by the cable service provider. This avoids the viewer having to possess the recording device and obtain a DVD or video cassette of the desire program. Thus, the viewer now relies on capabilities in the service provider's network for storing and playing back the requested programming.

One common motivation for invoking the fast forward trick function is to skip program material that may not be suitable or that is deem unsuitable for viewing for all family members. Thus, many parents restrict the ability to download movies because they do not want their children to view certain movies—specifically, certain portions of the movies. A parent might view the movie with their children and then skip certain sections which they would deem inappropriate for their children. However, this presents several obvious deficiencies. First, the parent has to know in advance which scenes are inappropriate, which may require the parent to have previously viewed the program, and be cognizant of upcoming scenes that are to be skipped. This may not be always practical or possible. Second, in the case of “on-demand” programs, the program in its entirety could be viewed at a later time by the child without having the parent present to define the viewing experience—e.g., the skipping over certain segments.

It is clear that different people will have different opinions as to which segments of a movie are inappropriate, and the ability to individually accommodate different version of viewing experiences has not yet been accommodated with video on-demand (VOD) services. Thus, any solution addressing this program must offer flexibility to accommodate differing opinions and the associated desired different viewing experiences without the above disadvantages

### BRIEF SUMMARY OF THE INVENTION

The invention generally pertains to systems and methods allowing for creating and/or applying an index to one or more programs to customize the viewing experience of a viewer of a program provided by a video service provider. In one embodiment, a user is able to create an index defining which segments of an identified target program are viewable (or conversely, not viewable) during subsequent viewings. In another embodiment, the same or different user is able to select and apply the previously created index when viewing the given program, thus providing a custom viewing experience. When a different user applies the index file, they are essentially altering the content that is presented to them without having to first view the content.

The above is only a general description of one embodiment of the invention, and other embodiments of the invention allow viewers to select multiple target programs, which are concatenated together, allow target programs that are not readily stored in the CSP's system, providing flexible advertising and pricing mechanisms based on the application of an index to a program. These and other embodiments will be evident in the following detailed description of various embodiments of the invention.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A and 1B illustrate two embodiments of an index file;

FIG. 2 illustrates one embodiment of the process of generating an index file;

FIG. 3 illustrates one embodiment of applying an index file;

FIG. 4. illustrates one embodiment of generating a multiple target program index file;

FIG. 5 illustrates one embodiment of billing for viewing a target program;

FIG. 6 illustrates one embodiment of advertisement insertion;

FIG. 7 illustrates one functional architecture of one embodiment of the present invention;

FIG. 8 illustrates one physical architecture of one embodiment of the present invention;

FIG. 9 illustrates another physical architecture of another embodiment of the present invention;

FIGS. 10A-10C illustrate user interfaces associated with one embodiment of the present invention; and

FIGS. 11A-11D illustrate further user-interfaces associated with another embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of computer software executing on processors in various system components in a cable headend. Any suitable computer-readable storage medium may be utilized including hard disks, CD-ROMs, optical storage devices, flash drives, or magnetic storage devices.

The present invention is described below with reference to block diagrams and flowchart illustrations of methods, apparatuses (e.g., systems and devices) and computer program products according to various embodiments of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, a special purpose computer, or other programmable data processing apparatus to produce a machine, such that the instructions which execute on the computer or other programmable data processing apparatus create a means for implementing the functions specified in the flowchart block or blocks.

Accordingly, blocks of the block diagrams and flowchart illustrations support combinations for performing the specified functions, combinations of steps for performing the specified functions and program instructions for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

As will be evident from the following, the present invention can be utilized by various video service providers (“VSP”), including cable service providers (“CPSs”) and Internet Protocol Television providers (“IPTV”), regardless of whether the service providers use wireline facilities or technologies (e.g., Internet broadband using HFC, fiber to the home, etc.), wireless communication technologies (LMDS, MMDS, WiFi, 3G cellular technologies, etc.), or a hybrid thereof. The present invention will be described in the context of a CSP, but it is not limited to only this type of VSP.

As will be evident from the following, the user is referred to as a “subscriber,” “viewer”, or “user” in various contexts. In many instances the viewer will be a subscriber of the VSP, but it is not required that the viewer be billed for services received from the VSP, as the invention can be embodied without the VSP charging the viewer. Further, a user of the system creating an index may be called a “creating user”, which may entail viewing the program. A user that is viewing a program and applying an index is a “viewing user” and they experience a custom viewing experience. As will be evident, the viewing user and the creating user can be different individuals.

As will be evident from the following, a “target program” or “program” is the video program (e.g., movie) for which an index is created or to which the index is applied. The phrase “target program” is usually used to refer to a program to which the index will be applied to (hence this is often used in context of creating an index), whereas a “program” often refers to the program being viewed using the index and to which the index presently is associated with. However, both terms “target program” and the “program” refer to the same video program and either term may be used, generally interchangeably. An index must be associated with at least one program, and it is possible that an index can be associated with multiple programs that are concatenated together when viewed. When this is the case, “multiple programs” or “multiple target programs” are referenced in this context as appropriate.

As will be evident from the following, the word “index” can be used as a verb and a noun. As a noun, an “index” is a collection of information that defines the viewing experience of one or more a target programs. The collection of information is typically embodied as a file, but other structures could be used. Hence, an “index file” is an index embodied in the form of a file. The information in an index typically comprises a target program identifier, which is used to associate the index with the program. The index identifies at least one segment (also called a “content segment” or “segment”), which is typically embodied as a record in the index file. The segment identifies a portion of the program, typically a beginning point and an ending point. Thus, a segment record in an index file usually has at least two pieces of data—the beginning point and the ending point. The index has at least one segment, because if the index did not have any, then the viewing experience of the program would not be altered when using the index. Typically, the index has more than one segment, but it is not necessary and may contain only one. The term “marker” or “markers” refers to generically either a beginning or ending point, or to a corresponding set of beginning and ending points. As a verb, to “index” refers to the process of creating or generating the index. Thus, indexing is the act of creating the markers defining a segment. It should be evident from the context which usage is intended. However, to aid in minimizing confusion between use of the verb “indexing” and the noun “index”, the verb “tagging” or “marking” may be used instead of the verb “indexing.”

### Service Overview

The capabilities defined herein are usually combined in different ways so as to allow a Video Service Provider offer a service (sometime referred to herein as “Indexing of On-Demand Content or “IOCD”) to its subscribers that generally involves the generation and/or application of an index for altering the viewing experience of a video program. The particular set of capabilities that are combined to form the service may vary from service provider to provider, and any combination as disclosed herein is encompassed by the “IOCD” service. Hence, it is possible to use the IOCD service by only creating an index or applying an index.

“Application of the viewing index” refers to viewing a program using an index, such that the viewing experience is customized. Specifically, application of the index to the target program typically results in a portion of the requested program being presented to the viewer, and at least one other portion being excised and hence not presented to the viewer. In one common embodiment, the segments identified in the index file are excised from the normal viewing experience. These segments are essentially “skipped” or passed over upon viewing the program; thus creating the customized viewing experience. Thus, although the user requests to view a particular program, the user is typically presented with a subset of the program, where a segment of the program has been excised is not presented. In other embodiments, the segments identified by the index are those portions of the program which should be shown to the user (and everything else is not shown). Each embodiment of the invention has different uses and benefits for users.

For example, if the index identifies segments of the program to be excised, this may be beneficial for allowing a parent to edit out identified segments from a program. Thus, a parent could effectively remove scenes from a movie that results in the movie having an “R” rating, and effectively provide what the parent considers a “PG” rated movie for viewing by their children. On the other hand, the index could identify segments of a program that are to be viewed. One application would be to allow a user create a series of segments from, for example, a sports program, such as the “best football tackles” from a particular football game. Another embodiment allows the user to select the best football tackles from several football games. This would allow the user to create a viewing experience of the “best football tackles” from an entire season of football games. Either embodiment is possible by applying an index to a program(s) and is within the scope of the invention. For illustration purposes, the former embodiment (wherein the index identifies segments to be excised) is largely used to illustrate aspects of the present invention.

There are typically three high level service capabilities that a user of the IOCD service may utilize. It is not necessary for a user to use all three service capabilities to use the service, as many users will only use one or two of the following service capabilities. These three service capabilities are: 1) Generating the Index; 2) Applying the Index, and 3) Searching for an Index.

As will be seen, these service capabilities at a high level describe a set of capabilities or functions that are related, but not all of the associated functions are required to be invoked in order to use a service capability.

Various sub-service capabilities are possible as well. For example, at a high level, generating an index may involve various functions for creating, editing, and/or publishing an index. Creating the index can occur using various techniques for defining the contents segments in one or more programs. Editing the index is an optional capability, which again can involve various techniques for modifying an index as it is being created or after it is created. Finally, publishing the index is a capability associated with allowing others to be aware of the index in order to apply the index in viewing a program. Publishing can be limited or broad in scope. Further, the index can be published to different locations or index repositories, which act as libraries of indexes. These indexes can be searched by the VSP or a user, so that it can be applied when viewing the program. Different service providers may access or share index files created by their subscribers, and make them available to their respective subscribers.

### Generating The Index

### Creating An Index File

It is necessary to generate an index before it can be applied to viewing a program and therefore customize the viewing experience. The creation of the index can be done by a different user than who is applying the index. Thus, it is foreseen than one viewer may create an index which can be shared and applied by others. This has the fundamental advantage of allowing a viewer to apply an index they did not create and benefit from the efforts and judgment of others who did create the index.

The generation of the index can be accomplished several ways. As noted above, the index for illustration purposes is presumed to identify segments to excise from a program. In one approach, the user views the target program using existing video on-demand service capabilities provided by the VSP. The user may find it desirable to have previously viewed the program previously, so that the user is familiar with the overall program and which segments should be excluded. When the user reaches a desired segment to be excised, the user will mark the beginning of the segment using a remote control (also known as a “remote controller”) that interacts with the set top box (“STB”). A function key on the remote control is allocated for marking the beginning of the content segment, and when pressed, the beginning point of the content segment is recorded by the set top box or communicated to the headend. As the program continues, the user determines when to tag the end of the excised segment, and by pressing the same (or another) function key on the remote control, the ending point of the content segment is noted by the STB. The process may be repeated as often as necessary as the user determines for the duration of the program.

In one embodiment, the STB is provided with an application program (that is downloaded using existing carousel techniques known in the art) that creates an index file comprising information identifying the target program, and creates a record for each segment. In another embodiment, the STB application program transmits this information to the headend, where a file is created and/or stored. The segments comprising a beginning data point and a second, ending data point, which corresponds to the points where the user invoked the appropriate function on the remote control. Further details on one embodiment for this capability can be found in Systems, Methods And Apparatus For Tagging Segments Of Media Content, filed on Dec. 31, 2008, and assigned U.S. patent application Ser. No. 12/347,430, the contents of which are incorporated by reference.

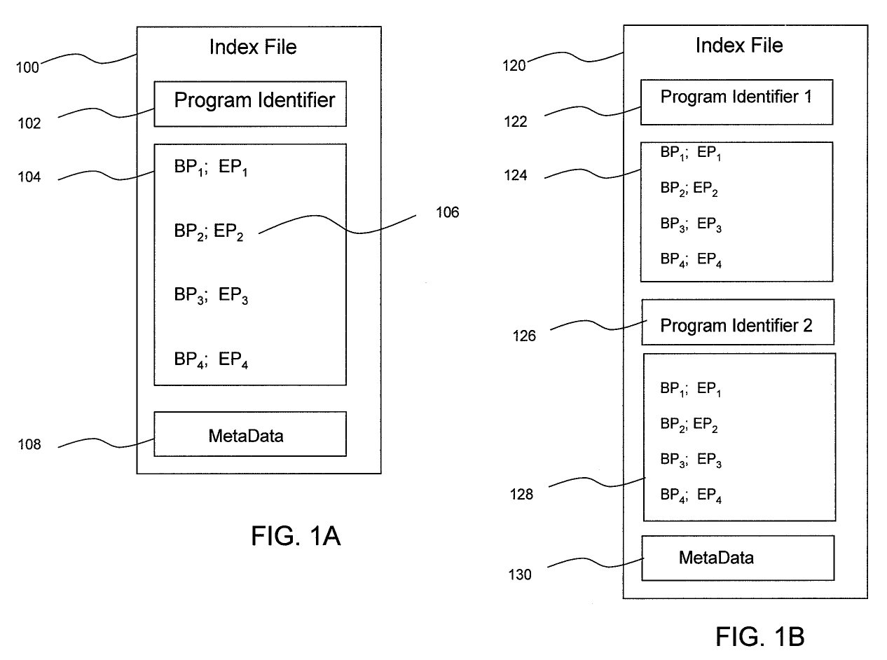

One embodiment of the file structure of the index file is shown in FIG. 1. In FIG. 1A, the file 100 comprises a name, which is unique for each index file created by the user. The file typically contains three types of information. This may be formatted in a XML or other data format. First, information identifies the program. This information may be derived by the STB using various sources. Typically, if the program being indexed was selected from an on-demand repository of programs, the STB is aware of the program, as it was selected for viewing by the user. Hence, the program identifier is known and is populated by the STB. In other embodiments, the information contained in this area is used to identify a pointer to another file, which in turn identifies the program. The identified program can be in the form of an asset identifier, as defined in industry standards for meta-data. In yet other embodiment, the program identified can be incorporated into the Index File name, thus potentially negating the need for a separate program identifier field. In some embodiments, the program identifier can be pointer, link, or address identifier, including a Uniform Resource Locator (“URL”). However, there must be some way of associating an index file with the program to which it pertains, and this information is incorporated into the index file in some manner.

The second set of information in the index file is the segment identifiers 104. There are one or more segment identifiers in an index file, and in this embodiment, they are illustrated as two data points (e.g., 106) (or “tuples”) comprising a Beginning Point” (e.g., “BP₂”) and an Ending Point (“EP₂”). Thus, in the embodiment illustrated, there are four segments identified, which correspond to four segments that are to be skipped when viewing the identified target program.

The segment identifier data points themselves can be defined in various ways. Typically, the values represent an “offset time”, that is a time from the beginning of the start of the program. This can be formatted in different ways, including a minutes, seconds, and fraction of a second format, or based on a number of “clock ticks” at a defined rate. Typically, this is defined down to a granularity of a fraction of a second, and can be defined to uniquely identify a single image of the video stream presented by the system. However, other embodiments can use differing offset scales and precision levels. In other embodiments, the second data point can be duration value, instead of a second time offset value. Thus, the segment could be marked by the beginning point of the segment, and the duration of the segment. Those skilled in the art will realize that these alternatives are functionally equivalent to identifying the beginning and end point using time offset values, as a simple calculation of subtracting the two time periods provides the duration of the content segment. Other variations are possible.

Finally, the index file may comprise other data. Although this other data is labeled as “Metadata” 108, in FIG. 1A, this can encompass a variety of information that generally pertains to the index file. The contents of the Metadata 108 field can comprise information defined in various industry standards, but is not limited so. For example, the Metadata may comprise the time at which the index file was created, an indicator of who created (e.g., name of a person or an organization). The Metadata may comprise a version identifier and a subjective rating indicator, or comments provided by the index file creator. Because it is possible for different index files to exist for the same target program, the Metadata can be used to distinguish the two versions. Thus, two separate index files can be associated with the same an “R” rated movie. One which has some scenes (e.g., segments) identified for being skipped over, and which is deemed to have a “PG” rating, while another index has further scenes are identified for being skipped, which is deemed to have a “G” rating. The Metadata allows indicating this information as well as any other information that the index file creator determines useful. As will be seen, such information can be useful in allowing other viewers to search and identify a particular index file they wish to use. For example, a user could be presented with the two index versions, one indicating a “PG” rating and the other a “G” rating, and select the index file they deem appropriate for application to viewing the target program.

In other embodiments, the segments may identify portions to of the program to include (not skip over or exclude). Hence, in some embodiments, the index file may have control information (not shown in FIG. 1) which identifies the segments as being inclusionary or exclusionary segments. In the case of inclusionary segments, it is possible that there may be segments of multiple programs that are concatenated together. (For example, the aforementioned “best football tackles of the season” segments that are played back-to-back, so to speak.) One embodiment of the resulting index file is shown in FIG. 1B, where the index file 120 comprising a first program identifier 122 followed by a first set to content segments 124, followed by a second program identifier 126, following by a second set of content segments 128, followed by the Metadata 130. Thus, it is possible to have a first program identifier of the opening season football game with various segments identified that should be presented, followed by the following football game program identifier with further segments identified, etc. This would create a series of segments from related programs which create a collage of video segments that the user creating the index deems useful.

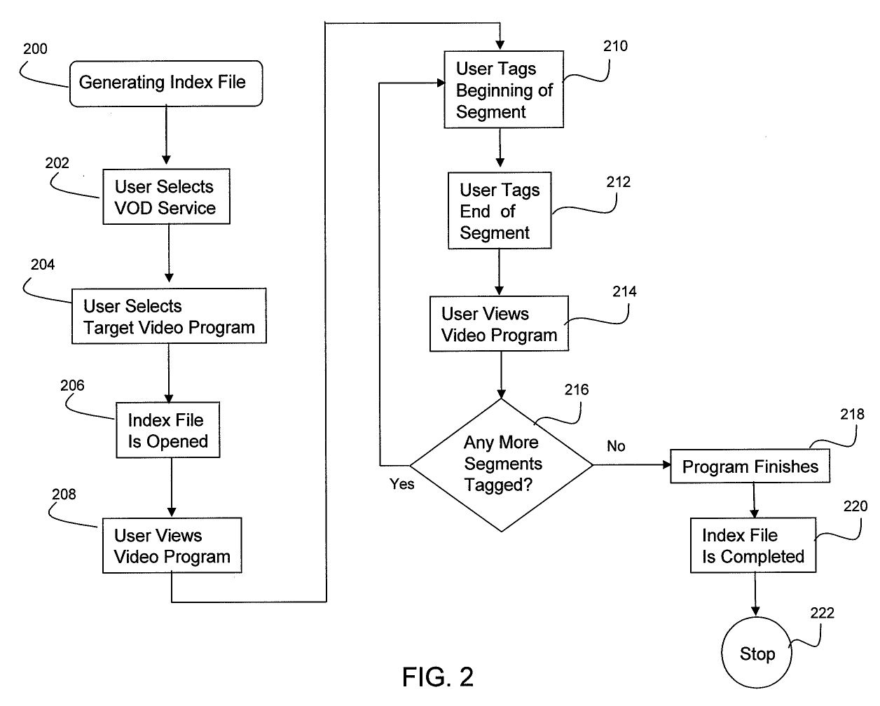

An exemplary flowchart of the user's process of creating an index is shown in FIG. 2. In FIG. 2, the process 200 begins with the user selecting the VOD service 202 provided by the VSP. This presumes that the user is indexing an on-demand video program. The user may invoke a variation of the VOD service which prompts the user whether indexing during viewing is desired. Alternatively, the service provider may augment the VOD service so that indexing can always be invoked. The next step in 204 is for the user to select the target video which is to be indexed. Again, the VOD service may be augmented to ask the user whether they would like to index the content they selected while viewing it or the VOD service may automatically allow this capability. In the next step 206 the STB will create and Index file for the target program. At this point, the index file does not have any content segments identified. Next, the viewer in step 208 views the program and when appropriate, invokes the tagging function on the remote control in step 210 to indicate the beginning point of the segment. The program is played as normal and the user then at the appropriate time tags the end of the segment at step 212. The viewer continues to view the program at step 214.

The user must tag at least one segment, otherwise the Index file would be empty, and in most embodiments, the STB or headend would erase the index file created in step 206 as no segments are tagged. Presuming at least one segment was tagged, the STB or a server in the headend would create the index segment record in the index file. As the movie is continued to be played, the user may tag additional segments as represented by step 216 looping back to step 210. If no further segments are tagged, then the program finishes in step 218 and the index file is completed in step 220, and the process is completed in step 222. The user may enter further information in step 220, such as the time the file was created, an identifier of the user, title description, comments, rating information, etc. In other embodiments, the STB may prompt the user to provide their name, subjective rating information, other comments, or other information that may be stored in the index file.

At this point, the user has successfully tagged a program, thus creating an index file that is stored either on their STB or in a server in the VSP. There are various exceptional handling procedures that are possible, and other variations on the basic procedure that can occur. For example, the index file could be limited to storing a maximum number of segments; the STB may preclude certain programs from being indexed; or require certain information from the user in order to complete the index file. These and other variations are possible, and can be defined by one skilled in the art as part of the procedures for creating the index file.

In the above embodiments, the index file was created by a user tagging segments by invoking a service in conjunction with a VOD service from the service provider. In other words, the VSP's on-demand service is used to present the video for which an index is created. In some embodiments, the index file may be stored in the STB for future application by the user, and in other embodiments, the index file may be transmitted to the VSP or created in the VSP, and stored in an index store.

However, in other embodiments, the index file can be created by using an application tool on a standalone computer (an “index authoring tool”). A video player editing software application can be adapted to allow a user to view a video program using the video player software that allows marking the beginning and ending points of the content segment. Such a stand alone computer program that runs on a PC or other computing system allows a user to create index files without relying on the VSP's VOD service, and also potentially allows more precise definition of the content segments and easier editing. The index file would be created and stored on the stand alone system, and could conform to any specified index file formats for use by a cable service provider. It is necessary to transfer the index file to the VSP if the index is to be used by VSP subscribers or users. However, this embodiment illustrates that the index file can be created using different techniques. Thus, the user creating the index does not have to be a subscriber of the VSP, nor has to create the index using a set top box, or a VOD service.

### Modification of the Index File

After creating an index file, the user may wish to modify its contents. This modification could occur in real-time as the index file is created, or subsequently, after it has been created. Continuing with the above example wherein a user is creating the index file by using a VOD service and tagging segments (i.e., creating markers) using a remote control interacting with the STB, the user may be able to also invoke other trick functions, such as rewind, pause, start (resume or play), and fast forward. As the user is watching the program, the user may decide to rewind a portion of the program being viewed, and insert a beginning segment content marker and an ending segment content marker. Upon rewinding the program to a certain point, the application software in the STB could be designed to “start over” at that point, effectively erasing segment markers that occurred after the certain point. To illustrate this, assume a segment has been marked with a beginning time at 1:35:10 (1 hour, 35 minutes and 10 seconds) into a movie, and the ending mark is 30 seconds later (1:35:40). Upon reaching the 1:36:00 point, the user decides to rewind the program to 1:34:00 and start over. The aforementioned markers would be erased and overwritten with the new markers. The markers previously created before the rewind point (1:35:40) would not be affected.

If a user has created an index file, then they can effectively override it by creating a new index file for the same program, by replicating the above described process by selecting the movie again and creating a new index. This process is relatively simple for a user to perform, though not as quick as using an index authoring tool.

If the index is creating using an index authoring tool, the user could be provided with a number mechanisms via a graphical-user-interface for directly editing the contents of the index file, or viewing the program with icons indicating on a timeline where the corresponding markers are provided. This can occur by the tool receiving input from of a mouse type input device and various graphical controls for editing the marks. This approach provides more flexibility for a user to create or edit the index file, but requires more training and a separate stand alone computer and corresponding software. Further, once the index file is created, it has to be uploaded to the VSP or otherwise loaded into the STB for application during viewing.

However, it is possible that such a tool would be used by organizations that create index files for a number of video programs. This approach is useful in embodiments where the program source is stored on a DVD, and a portable DVD player is used to view the program. Hence, the index file needs to be stored or access by the portable DVD player, which is applied while the DVD program is being processed and displayed to the user.

### Publishing of Index Files

In the embodiment where the user creates an index file using a VOD application in conjunction with a STB, the index file is created and stored in memory of the STB or in an index store in the cable service provider. In one embodiment, this allows the STB to apply the index file when the creating viewer subsequently views the target program. This is one embodiment that can be used in the aforementioned application when a parent creates an index file to be applied when the program is subsequently viewed by their children. Because the index file is stored locally, and will be used locally, there is no need to publish it (e.g., export or post it) to an external device.

However, in other embodiments, the index file is stored in the VSP or in a third party repository of index files. This allows creating users to share their index files. Specifically, a user desiring to apply an index file did not have to create that index file. For convenience, the user applying the index file is termed a “viewing user” (because they apply the index to a program they view) while the other user is termed the “creating user” (because they created the index). The viewing user needs to be aware of the existing of the index file. In most embodiments, the creating user will publish the index file to a central repository, which the viewing user can then access. Thus, the index is shared between the creating user and a plurality of viewing users. The scope of viewing users that are able to use the index file can vary and is referred to as the “domain.”

In one embodiment, the domain of viewing users comprises the users of the same VSP that serviced the creating user. If, for example, the VSP is a cable service provider operating several headend systems, then all the subscribers on the headend systems can potentially apply an index file created by one of the subscribers. In order to realize this, the creating user after creating the index file may be asked whether they would like to share the index file with other subscribers. This can occur by the STP VOD application generating a prompt on the screen after the program has been viewed, to which the user can answer “yes” or “no.” If they indicate “yes”, then the index file is transmitted from the STB to the headend, where it is stored in a server. In other embodiments, the index file may be automatically transmitted to the headend and made available to others.

In other embodiments, the index file may be transmitted as a file, which can be transmitted to a specified email address as an attachment, or uploaded to a specified web site (web portal). For example, if an index authoring tool is used to create an index file, the file could be stored on the stand alone computer system, and could be readily attached to an email message or uploaded when the user accesses the web portal. Existing techniques for transmitting or uploading files are well known and can be used to transmit the index file to a repository. It is possible to also email or upload the index file from the STB if the STB is provided with those capabilities.

It is possible that dedicated web portals can be used for uploading or downloading index files. Social networking sites could be used for users to post, publish, advertise, sell, rent, or otherwise make available their index files. Web portals allow the creating users to provide additional details describing their philosophy in creating the index, and can provide flexible searching tools for identifying index files, as well as presenting other information which a viewing user would find useful in selecting that index. Web portals typically also provide a richer graphical user interface for interacting with such search tools.

### Searching for Index Files

In order to identify an index file to apply when viewing a program, the viewing user must be aware of the index file. Because it is possible for various creating users to each create their own index file for the same target program, the viewing user may have to select one of a plurality of index files that should be applied. This requires the viewing user to be able to select and identify the desired index file.

How a viewing user selects an index file is dependent on where the index file was transmitted or uploaded to. Three different destinations were previously identified as receiving an index file: 1) the video service provider serving the viewing user, 2) a specified email address, and 3) a web site. Thus, the viewing user could download the index file from the same service provider, use FTP or some other file transfer protocol to retrieve it from a computer system, or access a web site and download it. For practical considerations, only the first and third approach as discussed further.

If the viewing user obtains the index file from the VSP, there are at least two embodiments possible. First, the VSP may store the index file itself that was created by one of its subscribers, and provide the viewing user with a listing of index files that are available with its video programs in its VOD library. (The word “listing” is used in lieu of the generic concept “index,” because the word “index” herein is used to have a specific meaning). Alternatively, the VSP may maintain a listing of index files that are stored by the VSP or by other service providers. This increases the domain in which a viewing user can search for index files. This presumes that various VSPs regularly share their lists of index files. It is possible that cable companies may share such files.

### Identifying and Applying an Index File

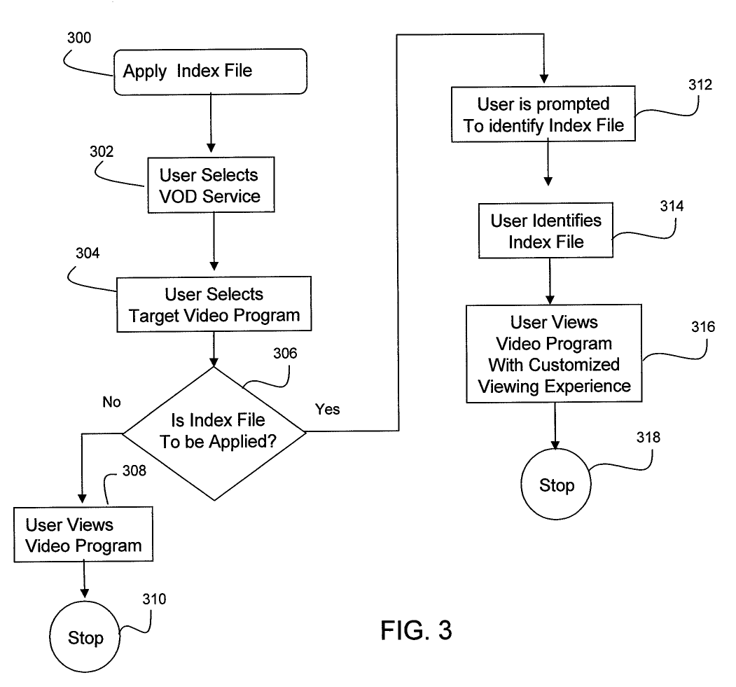

One embodiment of the process of applying an index file is shown in FIG. 3. The first embodiment is illustrated in FIG. 3. In FIG. 3, the application of the index filed 300 begins with the viewer using the VOD service which is selected in step 302. The user then identifies the video program using techniques established by the VOD application in step 304. After selection of the program, the VOD application executing in the STB prompts the user whether an index file is to be applied in step 306. If the user indicates No, then the viewing experience is normal and the user views the program in step 308, after which, the process stops 310. The program is shown the user in its stored form, although advertisements may be inserted. However, no portions of the program are excised or skipped.

If the user does indicate that an index file is to be applied as shown in step 306, the user is prompted to identify the index filed in 312. After this is identified in step 314, the viewing user is then presented with the program as modified by the index file in step 316.

The procedures for prompting the user to identify the Index File in step 312 are varied. In some embodiments, after the STB will receive information on existing index files stored in the VOD system pertaining to the selected program. As noted before, there may be several index files created, which are variously identified, which the user can select from. These indexed files may be displayed in a menu format can be identified using the aforementioned Metadata that identifies the creating user. Thus, after the user indicates an index file should be applied, the STB may prompt the user to select from the index described as in the following example:
a. “Family Association for Non-Violent Programming, created Nov. 1, 2009, Suitable for all viewing ages.”
b. “Jane Doe, created Jul. 4, 2008, Recommended for ages 6 and up.”
c. “John Smith, created Apr. 1, 2009.”
   In this embodiment, the STB receives and display data from the Metadata field comprising: 1) the creating users' name (individual or organizational), 2) data created, and 3) comments provided by the user regarding suitability.

The viewing user may have previously used an index by the creating user, or may trust the organization creating the index, such that the viewing user selects a desired index file based on the Metadata displayed. In other embodiments, the VSP may limit the index to a single index, or a single index for an effective program rating (e.g., one index for PG and one for G). The viewing user can select the desired index file by using a key function on the remote controller, a mouse, or other input means readily known in the art.

In other embodiments, the STB application may not limit the number of index files available to those stored in the VSP. Rather, the cable headend upon receiving input that an index file is to be applied, performs a search of other sources for index files created by others. Thus, there may be a central repository maintained by various organizations (e.g., the hypothetical “Family Associated for Non-Violent Programming”) which can be queried by the VSP and incorporated in the results sent to the STB. Other search techniques may be employed. In other embodiments, a group of VSPs share with each other a list of index files collectively maintained, which are indicated to the viewing user.

In other embodiments, the viewing user may search independently of the VOD application for an index file. For example, the viewing user may be aware of a central repository of index files which are maintained by an organization, which the VSP is not aware of The viewing user could use a personal computer via the Internet to become aware of such web portals. When the viewing user is prompted to identify the index file in step 312, the user can then indicate an URL or file location where the index file can be retrieved, having determined previously the location. Thus, the viewing user is not limited to the index files known by the VSP, or limited to the index options indicated in a menu by the STB. In one embodiment, the user may have downloaded the index file to a personal computer that is used to view the program (such as in an IPTV environment). In this case, the user may identify a local index file stored in the computer that is to be used.

In other embodiments, a potential viewing user can request notification via email when a recently created index file is available. For example, a parent may be waiting for an index file to be created for a recent movie release before allowing their children to view the movie. It is readily foreseen that viewing users may search for paper or on-line catalogues or web sites for recently release index files.

The actual application of the index file when viewing from a user perspective was illustrated in FIG. 3 in step 316. The viewer is presented the video program, but with the identified portions skipped. The non-skipped portions are automatically concatenated, so that the viewer is presented with an uninterrupted video stream. Thus, the processing device caches the video, determines whether the video should be excised based on the index file, and if not presents the video. Once a beginning point is encountered, the processing device jumps ahead to the ending point, and picks up streaming the video at this point. This is done for each content segment in a seamless manner. While it is likely that the scenes in the video may be discontinuous due to skipping the excised sections, the video stream itself is not interrupted. Consequently, the user is presented with a shortened version of the program.

### Operational Aspects

There are various operational embodiments that are possible, and these are described in the context of the above example examples where a VOD service is used to view the target program.

### Processing of Index File During Video Streaming

The index file is processed in conjunction with the video program depending on whether the content segments are exclusionary or inclusionary. Assuming the contents segments are exclusionary, the video program is streamed until the first beginning point of the first content segment is encountered. The video data of the program beginning with that point is then skipped until the ending point of the content segment is reached. The device streaming the program data can calculate the time duration of the content segment, and calculate the amount of data that should be skipped. Other mechanisms well known in the art can be applied for effectively skipping a section of the video stream. This processing typically occurs in real time, or in advance of the program being streamed to the user, after the index file has been identified. If the content segments are inclusionary, then only the identified portions are streamed out.

The location of the device performing the above processing can vary. In one embodiment where the VSP is a cable service provider, and the processing is performed in system located in the cable headend, such as the VOD server. In other embodiments, the device performing the processing is in a stand alone device, such as a personal video player. For illustration purposes, the following discussion will assume that the processing of the target program in context of the index file occurs in the cable headend. The cable headend maintains a server that has the index file selected by the viewing user before streaming out the program. The index file may be stored in the VOD server, or the VOD server may retrieve the indicated index file from another system present in the cable headend, or maintained by an external repository. Once the VOD server has both the program file and the index file, the program file can be processed and streamed to the user. In one embodiment, existing VOD procedures are used to select a channel to stream the customized program and instruct the STB to tune to that channel to view the customized program.

In another embodiment, the location of the device performing the processing can be located in the viewing user's equipment. Typically the location is in the STB, but in other embodiments, it could be a personal computer. Assuming it is the STB for illustration purposes, the index file must be present in the STB. In one embodiment previously discussed, the creating user previously created the index file using the STB, and hence the index file is already stored in the STB. In other embodiments, the index file is not stored in the STB, and it must be downloaded to the STB. The cable headend can transmit the file to the STB prior to streaming the program to the STB, where the STB then applies the index file to excise the indicated content segments. Prior to the cable headend transmitting the file to the STB, the user must previously provide information identifying which index file is to be used. This can be done via the aforementioned procedures.

### Multiple Target Programs

The prior examples focused on generating and applying an index to a single target program. In other embodiments, the index can be generated and applied to a plurality of target programs, which are concatenated together to create the viewing experience of the user.

The creating of an index is more complicated from a user-interface perspective when multiple programs are involved. Whereas creating an index for a single VOD program is fairly straightforward, and can be accomplished using a relatively simple graphical user-interface, and hence is possible by using a simple menu structure augmenting a VOD service, indicating multiple programs is more complicated. Hence, this lends itself towards using an index authoring tool, which can be executed as a stand alone personal computer. However, it is technically possible to provide this via the VOD service, by providing more menus in conjunction with a set top box.

Presuming an index authoring tool is used allows ready utilization of various input devices well known in the art. In one embodiment, the user indicates that multiple programs will be involved by identifying them appropriately. This may require having previously downloaded the target programs on the index authoring tool, or otherwise having the target programs readily downloadable to the index authoring tool. The user then views the first program, and appropriately identifies the beginning and ending points of each segment. After the first program is completed, the user will then identify (or select) the second program, and repeat the process for the second program, and so forth. The resulting index file will identify each program and each set of content segments as appropriate. A set of Metadata is typically also provided by the user and incorporated into the index file.

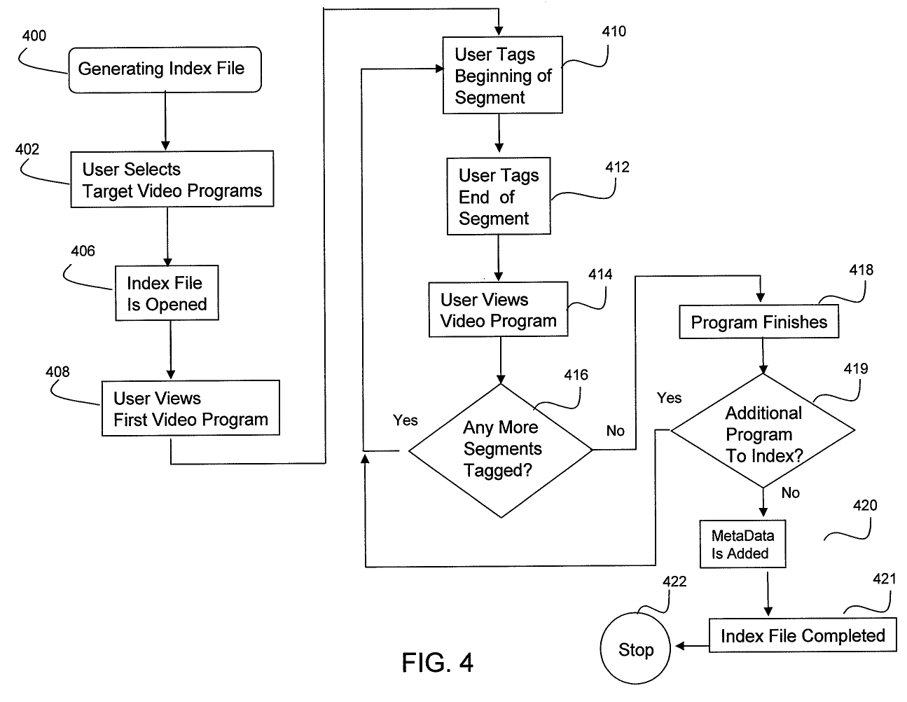

One embodiment for creating the index file is shown in FIG. 4. In this embodiment the user identified in step 402 the video programs that will be indexed. This can be two or more, and the programs can be identified in a variety of ways, including identifying URLs, or file locations. The index authoring tool then opens or creates and an index file in step 406, and the user proceeds to view the first video program in step X08. In step 410, the first content segment beginning point is tagged, and a corresponding end point is tagged in step 412. This is repeated as necessary in steps 414 and 416. Once the program finishes in step 418, the next program, if there is one, in step 419 is processed. If there is one, then the steps of 410-418 are repeated as necessary. If there are no further programs to index, then the Metadata in step 420 is added and the index file is completed in step 421. The process is completed in step 422.

From a user's perspective, the application of a multiple program index file during viewing results in an experience similar to the application of a single program index file, except however, that content segments from multiple programs are viewed. The user is provided with a series of content segments from the first program, and then seamlessly provided with another series of content segments from the second program, and so forth. In some instances, the user may not necessarily even know that the segments are concatenated from different programs when viewing the programs. For example, in the aforementioned example of viewing a concatenation of plays in various football games (e.g., the “The Best Football Tackles of the 2009 Season), a number of content segments from a number of football games may be concatenated and presented seamlessly to the viewer.

The operational processing when applying a multiple program index file is different in the VOD headend. Typically, the VOD server is aware that multiple programs are involved, and must ensure that all programs are available and can be provided to the viewer before beginning the process. Assuming for sake of illustration that two programs are involved, if the second program is not available, the VOD server may elect to not play the content segments from the first program. Further, even if both programs are available, the VOD server will need to verify that the user is authorized to receive both programs. For example, the VOD server may, in some embodiments, ensure that the multiple programs are readily available in memory or accessible from their respective storage systems, or compatible with the user's subscription levels (e.g., one program may be associated with a premium service level to which the viewing user is not subscribed to). It is also possible that the VOD server may limit the multiple target programs to those programs stored in its VOD library. In other embodiments, the multiple target programs may be identified via URL addresses and are video programs located on external systems to the VOD server.

The searching capability for an index file is slightly modified when multiple target programs are involved. In the previous embodiment, where a single target program is involved, the searching is typically based on the target program (typically, its title). Thus, for example, a parent desiring to view a particular R rated movie for which an index has been created (thereby effectively providing a “PG” viewing experience for the same movie) would search for an appropriate index based on the target program title. The search for the index file may also be based on a particular index creator. Thus, the viewing user could search both on the originating entity and the target video program (e.g., search for “John Doe's index for the latest Star Trek movie). However, when searching for an index file based on multiple programs, it becomes obvious that a single movie program title may not always be appropriate. The inclusion of multiple programs typically requires a different searching strategy. In one embodiment, searching is based on the subject matter or other comments provided by the index file creator, specifically, those found in the Metadata field.

The index file creator may provide a descriptive title, subject matter or other comments that suggest the content. This may be in created in a format compatible with industry standards for metadata, including well known CableLabs® metadata specifications, or the “TV Anytime” specification used in other countries. For convenience purposes, these potential various descriptors will be referred to by the label “title description.” The title description may be the basis on which the viewing user conducts a search. For example, title descriptors may suggest the type or source of the target video programs—e.g., “Best Chase Scenes of Indiana Jones” or “Best Tackles of the 2009 Football Season” or “Ginger Rogers' Best Dancing Scenes.” In these examples, the target programs comprise a series of related movies, or a particular type of programs, or programs involving a common actor. It is readily apparent that a wide range of title descriptions can be created suggesting a wide variety of subject matter and/or programs involved. Of course, searching based on the target program is still possible, but it may not be as useful.

Regardless of whether a single target program is involved, or whether multiple target programs are involved, the streaming of the program content may involve incorporating of digital rights management. Each program may require the appropriate digital rights authorization to play the program, and existing mechanisms for obtaining a license (essentially a form of decryption key) to view the target program may be utilized. In some embodiments, the index file may include optionally include digital rights management information, or the set top box may rely on other mechanisms for receiving authorization. The authorization may be defined for each program or content segment.

### Billing Options

The application of an index file when viewing a target program(s) offers an opportunity by the VSP to provide alternative billing arrangements. Recall that one application for applying a viewing index is to skip over certain content segments in a movie, thereby facilitating parental control. The percentage of the movie skipped may be relatively small, relative to the entire length of the movie. For example, a parent may elect to apply an index to remove nude scenes in a movie which amount to less than one minute in duration. The parent may then elect to view the target program using a VOD service, and the service provider may charge subscribers for viewing the program. However, the VOD service provider may elect to alter the billing based on whether an index file was applied, and/or how much of the target program was viewed.

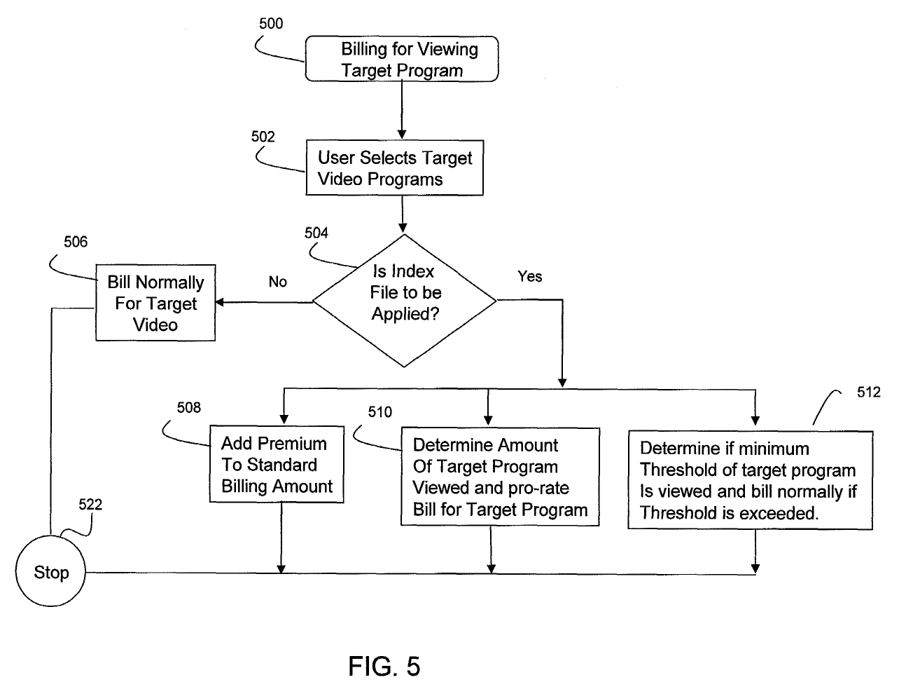

FIG. 5 illustrates some embodiments that are possible. In FIG. 5, the process for billing a viewed target program 500 begins with the user selecting a target video program 502. In typical embodiments, this will occur using a VOD service. In the next step 504, it is determined with an index file will be applied to the viewing of the target program. If not, then in step 506, the normal billing algorithm is applied (which typically is a set price). However, if an index file is applied, then the service provider may bill for the service in various ways. In one embodiment, at step 508, the service provider may add a premium amount to the standard billing amount. In another embodiment, the service provider in step 510 may prorate the bill for the target movie based on how much of the movie is viewed or skipped. For example, is 10% of the program is skipped, then the price for the program may be dropped by 10% (or some other amount). In yet another embodiment, the service provider may set a threshold level, indicating a minimum duration of viewing of the program which then triggers billing of the program at the regular price. For example, if more than 50% of the target movie has been viewed when applying the index, this may trigger billing the subscriber for the entire movie. Obviously, there are many variations on the billing procedures that can be defined based on whether an index file was applied and how much of the target movie was viewed. FIG. 5 discloses only a few of the possibilities.

### Insertion of Advertising

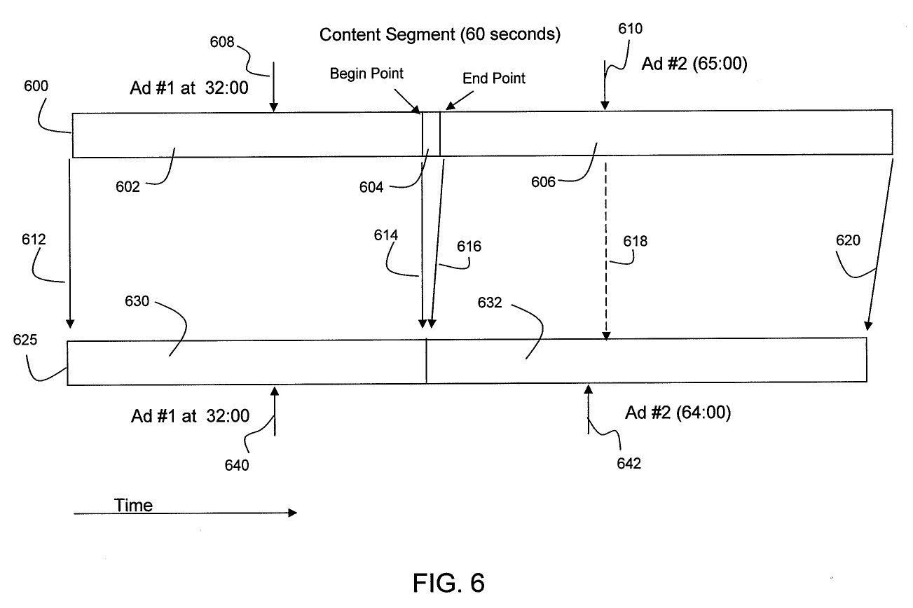

When viewing a program via VOD service, the service provider may insert advertising during viewing. This may be done in accordance with various standards promulgated by the Society of Cable Telecommunications Engineers (“SCTE”) such as SCTE 35 and SCTE 67 standards. Typically, if the viewer pays for viewing the program, advertising is not inserted, but if the program is provided without charge, advertising is inserted. Typically, the insertion of advertising occurs at certain points, which are indentified as “avails.” This is illustrated in FIG. 6. These points are not randomly selected, as doing so may insert advertising at the climax of a dramatic scene. Thus, the program producer or service provider may define certain points for which advertising may be (but not required to be) inserted.

In FIG. 6, the program is represented as a linear rectangle 600 which has scheduled two ads. The first ad 608 is defined by an avail at 32 minutes and zero seconds (32:00) into the program, whereas the second avail 610 is defined at 65:00 minutes. Typically, the ad is inserted at a point based on the contents of the movie, e.g., after a particular scene.

In this example, the program 600 has an index file created which excises one content segment 604 which is defined by the beginning point and ending point as shown. For purposes of illustration, the exact point where this occurs is not relevant, but it is assumed that it excised segment is 60 seconds long and is between the first and second advertisement.

When the index file is applied by a viewing user, the viewing experience is represented by the program 625 shown below in the figure. In this case, the program can be considered as comprising a first part 630 which corresponds to the first portion as shown by arrow 612 and 614. Because the content segment 604 is excised, the resulting program only has a second portion 632, as shown by arrows 616 and 620.

The original avail for the ad 608 can be mapped to the viewing program at the same time (32:00) 640. However, the second avail X10 from the original program is shifted from the starting point when mapped to the viewed program. Specifically, the second advertisement avail X42 should be presented at 64:00, which represents a shift in time based on the excised content segment. This would preserve the placement of the advertisement at the same intended location.

Consequently, the avail markings for a program viewed using an index file may have to be recalculated relative to the original avail markings. In other instances, it may be that the excised content segment is so lengthy, that an avail scheduled therein is completely removed as well. Other embodiments may instead relocate that avail to another portion of the viewed video program.

In some embodiments, excising a segment may result in an advertising avail to be removed. Thus, application of the index file to the target program would removing an opportunity by the service provider to insert an advertisement, or remove the advertisement if already present. In such embodiments, the removal of an advertising opportunity impact the billing of the target program to the viewer. Thus, removing advertising may result in a charge (or increased charge) to the viewing user.

### Normalization of Bookmarks

Some service providers allow a viewer to create bookmarks when viewing on-demand content (without application of an index file). These bookmarks may be added when the viewer pauses a programs, and resumes viewing the program at a later time. Thus, the viewer can exit the program, and resume viewing it a few hours later at the same point. If the same viewing then views the same program but with application of the index file, these bookmarks may be erased. On the other hand, creating a bookmark when viewing a target program (with application of an index file) may similarly be erased if the same viewer then chooses to view the same target program without applying the index file. Other embodiments may alter the relative location of the bookmark when viewing the target program with or without the applying the index file. Various embodiments can modify, disable, or otherwise alter operation of the bookmarks when applying an index filed when viewing a target progam.

### Real Time Indexing of Broadcast Content

The target program when viewed by the viewing user must be a previously stored video program, and hence must be viewable upon request. In one embodiment, the program is part of the VSP's VOD library of programs. Further, typically the program is viewed on-demand when the index is created. However, it is possible to create real time index for real-time broadcast programming. In such embodiments, either automated systems are programmed to create an index, or a person watching the live program creates an index file. In such embodiments, the broadcast program is stored, and thus it becomes available for viewing on a demand basis.

In embodiments where an automated system is used, various inputs can be processed to determine which sections of a program (or programs) to include or exclude. For example, in one embodiment, an automated system uses speech recognition to excise content comprising potentially offensive language. Thus, the index file is created in real time based on processing the audio information.

In another embodiment where the index file identifies the portions to include (or view), the audio channel may be analyzed to define such portions. For example, in a live basketball game, a certain decibel level of the crowd may indicate excitement (due to points being scored). Thus, an automated system could identify segments where the crowed noise is high, and compile a “highlights” video of the broadcast game. In both embodiments, the automated system could generate the program information by accessing an electronic program guide, or otherwise being programmed with that information.

### Combining Index Files

It is possible in some embodiments for a viewing user to select multiple index files to apply to the same target program. Specifically, assume there are two index files have been created, and offered to the viewing user. The viewing user could select both index files. Upon doing so, the result would be to process both index files to produce a third index file by merging the indices of both index files into the third. Thus, the excised content segments of the result would be the superset of the content segments from the first index file and the second index file. This superset of content segments would then be applied to customize the viewing experience.

### Functional Architecture

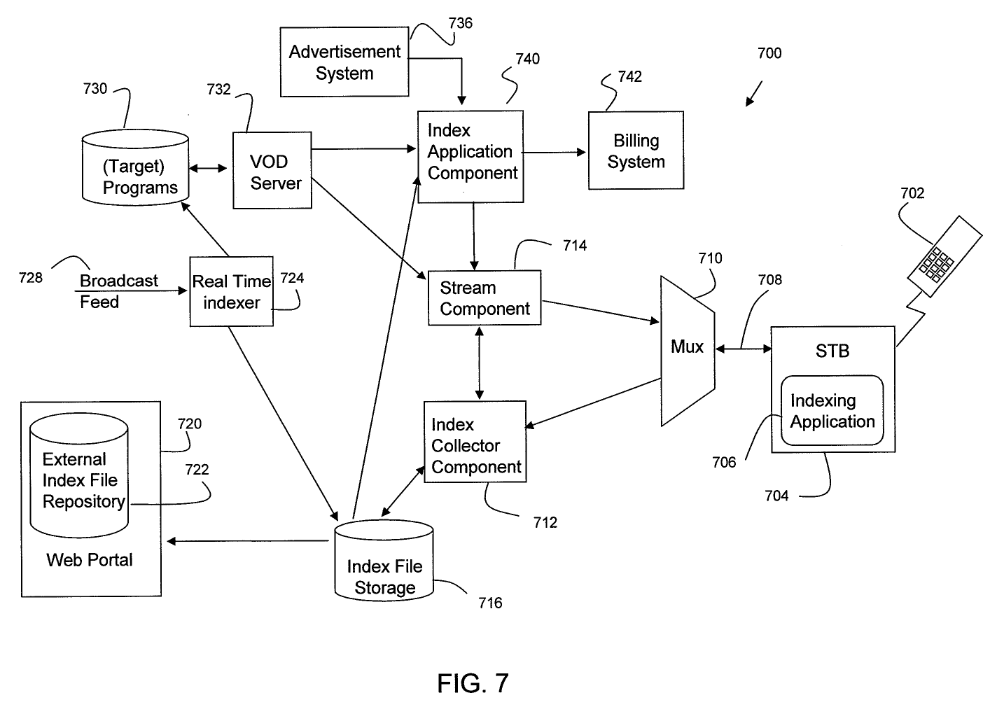

One functional architecture of the present invention is shown in FIG. 7. In FIG. 7, various components are shown that may be involved in an embodiment comprising a cable service provider, which is one form of video service provider. These components may be embodied as software modules executing on processors, or specific hardware which is programmed to accomplish the indicated functions.

A user manipulates a remote control 702, which is a handheld device comprising various function keys that communicates wirelessly with a set top box 704. The set top box is attached to a television (not shown) and provides the signals to the television for viewing by the user based on signals on the cable network 708. The set top box comprises an indexing software application 706 that is typically downloaded to the set top box using existing data carouseling techniques known in the art. The indexing application may be an augmented VOD application, or a separate application which the VOD application may interact with.

The user begins the process of creating an index file by first selecting a program to index. In this embodiment, it is presumed that the creating user is selecting a VOD program via a VOD service offered by the cable service provider. Thus, the user invokes the appropriate function keys on the remote control 702 cause the STB to communicate with the VOD server 732 to retrieve the appropriate program in a data store 730. The VOD data store maintains copies of various programs as digital video files in MPEG (or in other or additional formats). The VOD also maintains associated Metadata about the video program, which includes various information about the program. The program is then provided to the VOD server 732, to the stream component 714, which is streamed via the headend, including a multiplexer 710 over the cable distribution network 708 to the user. When the program, or more specifically, the digital video file is provided from the VOD sever to the stream component, this can be provided by actually streaming the digital file to the stream component, or providing pointers to the digital video file in the video store. The later allows the stream component to request directly to the store the program. Other arrangements are possible as known by those skilled in the art. The VOD service can be provided consistent with existing techniques for providing video on-demand programs.

The stream component may perform transcoding, rate shaping, and/or other conversion functions which are necessary to process the MPEG transport stream to through the cable distribution plant and to the viewer's set top box.

As the user is viewing the program, the user can elect to mark content segments. The indexing application 706 in the set top box receives user input from the remote control to indicate the tagged content segments. In one embodiment, the user selects a function key on the remote to indicate the beginning point, and an indication is received by the indexing application. When the user selects the same function key again (or a separate function key) indicating the ending point, the indexing application is again notified. The inputs from the user are typically not numerical values per se, but are indications which are processed in real time to determine a time offset into the viewing of the program. Thus, pressing the function key twenty minutes after the program has started may result in a numerical value being recorded corresponding to that time measure.

The indexing application may create an index file, or it may communicate the beginning and ending points to the index collector 712 in real time which creates the index file. The index application 706 is able to communicate over the HFC distribution network 708 through various headend equipment, including a multiplexer 710, to the index collector module 712. The index collection may be based on the “click-to-clip” server as disclosed in the aforementioned Systems, Methods, And Apparatus For Tagging Segments Of Media Content, filed on Dec. 31, 2008, and assigned U.S. patent application Ser. No. 12/347,430, the contents of which is incorporated by reference.

Presuming that the index collector creates the index file comprising the beginning and ending points, the index collector does this by querying in real time the stream component 714 that is streaming the video program to the user. The stream component responds with data values defining the appropriate beginning or ending point of the content segment in response to the query. The index collector collects the responses and creates the appropriate record in the index file. Thus, the first data point is determined by the first input from the user, which the system determines which corresponds to the beginning point. The second data point is then determined based on when the second input from the user is received, and this corresponds to the ending point of the content segment. As noted, the time offset can be determined by any number of metrics and techniques. This embodiment requires that the indexing application indicate which program or channel is being queried, so that the index collector can respond with the appropriate program marks (the stream component typically streams multiple programs simultaneously). To complete the index file, the indexing application may accept further input from the user regarding the Metadata, such as the aforementioned title descriptors from the user. Other portions of the Metadata (such as time/date of creation) may be generated by the indexing collector. Once the index file is completed, the index file is stored in a local index file storage system 716. It is also possible that the index collection will also transmit the index file to the set top box for future use.

The index file created may be transmitted from the index file storage 716 to a remote index file repository 720. The remote index file repository 720 comprises a database 722 with other creating user's index files, and this may be hosted by a server as a web portal allowing remote retrieval and searching of index files.

The above describes the major components or modules involved in one embodiment of generating an index file. Next, the module involved in applying the index file to a target program is examined. In this embodiment, illustration of the invention is facilitated by having the creating user being the viewing user, although it is not always required to be the case. At a later point, the user may elect to apply the index file by selecting the target program. This is accomplished by the user accessing the VOD server 732 and requesting viewing of a specified program in the data store 730. The user will be then prompted as to whether they would like to apply an index to create a custom viewing experience. In one embodiment, the VOD database 730 flags each program for which an index exists, whereas in another embodiment, the VOD server will query the index file store 716 using the indicated title to determine if an index file is available. Alternately, categories of index titles may be searched in various locations. Assuming there is an index file, and the user does select it, the VOD server then streams the file to the index application component (“IAC”) instead of the stream component. In one embodiment, this can be a software module running a general purpose or specific purpose processor.

In other embodiments, the index application component may search other sources for index files pertaining to the target program. This search could be initiated by the index application itself or in response to a user request. Thus, various known searching technologies and methods can be incorporated or used by the index application to locate index files stored in various web portal 720. In other embodiments, cable service providers may operate the repository, or allow access to their local index file stores by other cable service providers. In the remaining discussion, it is assumed that the Index Application retrieves an index file stored locally in the index file store 716.

The IAC module receives the target program and obtains the appropriate index file from the index file store 716. The IAC module processes the target program using the index file to skip the identified content segments. Typically, this is accomplished by reading in sections of the program video file into a buffer, so that the portions of the video file can be checked which, if any portions correspond to excised content segments. If the buffer contents are not to be excised, then they are stream out. If a portion is to be excised, then that portion is skipped, and the next portion is read into the buffer, until the ending point can be determined, at which time the data continues to be streamed out. Various techniques and methods for doing so are possible. The resulting customized video stream is then provided to the stream component 714, which in turns streams the customized video to the headend 710, and then to the set top box 706. The above describes the application of the index file to the program to create the customized viewing expenence.

The IAC may elect to insert advertising into the streamed program, and hence the IAC may access an advertisement system 736 for receiving advertisements. Further, the IAC may interact with a billing system 742. The viewing user may be billed based on which program is selected, how much of the content is excised, whether advertisements are inserted, as well as other factors known to those skilled in the art.

The cable service operator may also function as the creating user in a manner by receiving a broadcast feed of real time programming and storing the program in the VOD database 730 while creating an associated index file. This is accomplished by a Real Time indexer 724 that receives programming from a broadcast feed 728 and stores the program into the VOD system, making it generally available. Currently, the real time indexer creates an index file that is place into the index file store 716. Previously, it was discussed that a viewer would create an index file by visually deciding when to define the content segments. In one embodiment, the real time indexer may function on an automated basis by receiving data from other sources that is processed to determine when to create the content segments. Such data could allow automating of the process, in order to select certain content segments that are popular. For example, real time feedback could be obtained from users (whether viewers, or focus groups viewing in real time) as to which sections of a program they like. Such inputs could be used by the real time indexer to create, for example, the most popular segments of a live sports broadcast. For example, monitoring an overall crowd noise level of a live broadcast basketball game could allow a real time indexer process to select what are the probable game highlights. Thus, a viewer could view the game after it is loaded into the VOD server and view the highlights, which are defined by the crowd cheering.

The functional architecture is an overview of the various components in one embodiment, and other components may be present to facilitate operation. For example, the various components in the figure typically are implemented in separate computing systems, and a LAN and other routers and communication devices are involved.

### Physical Architecture

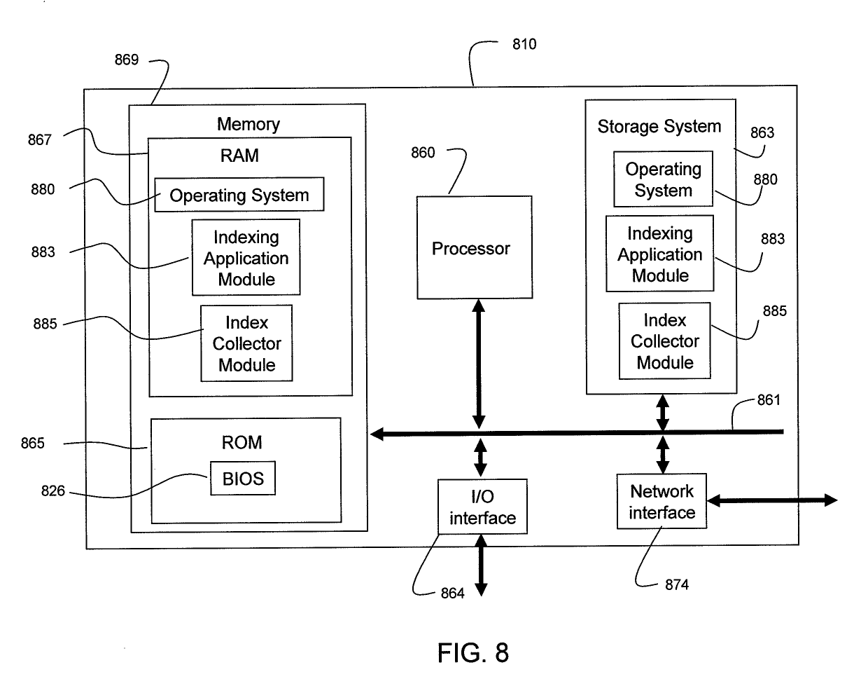

In the above functional architecture, the Index Collector and the Index Application components provide the functions for respectively creating and applying an index file. One embodiment of physical architecture of the system comprising these modules is shown in FIG. 8. In FIG. 8, the two modules reside in an Indexing Server 810. These may be implemented using a single or distributed processing computing system, or other arrangements known to those skilled in the art.

In FIG. 8, the computing system 810 comprises a processor 860 which can be single microprocessor, or achieved using multiple processors. The processor communicates with a communication bus 861, allowing it to communicate with a storage system 863, such as a disk or flash memory device. The storage system 863 comprises an modules defining executable code, including an operating system module 880 for controlling the system, an indexing application module 883 which applies the index file to a target program when viewing the target program, and the index collector module 885 which receives the user's input defining when the beginning and ending marks are for a content segment. The same modules are typically also loaded into the RAM portion 867 of memory 869. This allows faster execution of the program steps, and the memory 869 also communicates its information to the processor using the bus 861. The memory 869 also comprises ROM 865 or other types of non-volatile memory, which may store various basic input/output routines 826. Finally, the system 810 typically includes an input/output interface 864 for communicating with external local devices and a network interface 874 for communicating via a local area network with the other functional components in the architecture.

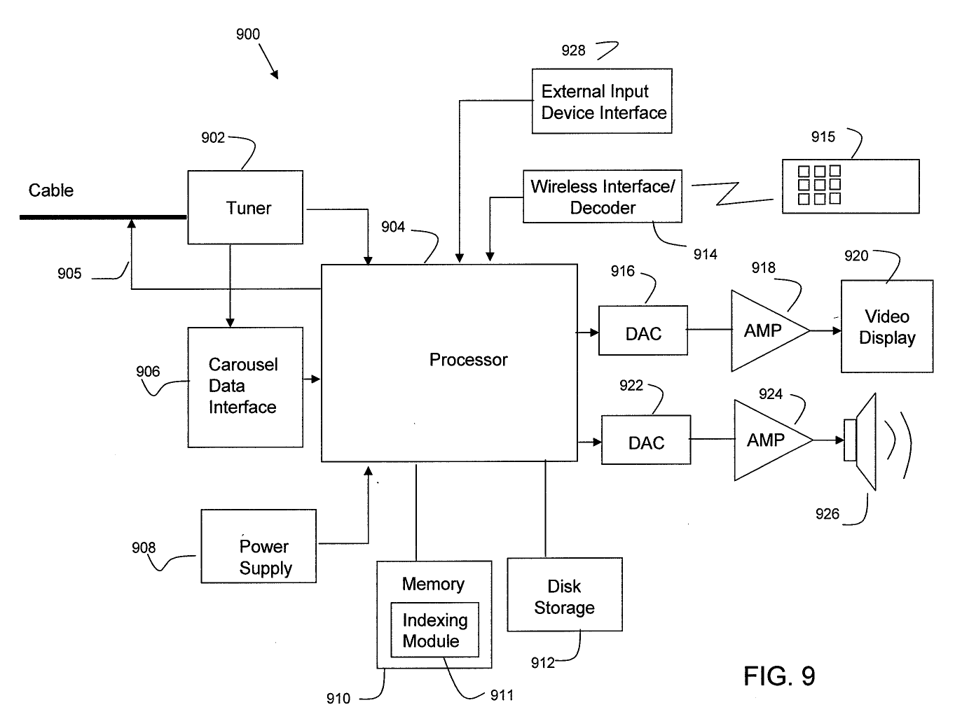

In one embodiment of the previously discussed functional architecture, the set top box performed various functions involving receiving input from a user for marking the endpoints of a content segment. One physical architecture of the set top box is shown in FIG. 9. The particular set top box depicted in FIG. 9 is configured to receive a digital signal from a cable company and to convert the signal into audiovisual content that is typically displayed on a television. However, as noted above, the set top box is not limited to a device used to receive a digital signal from a cable company. For example, the set top box may be a device configured to receive a digital music signal from a satellite radio provider. Thus, the set top box depicted in FIG. 9 is for illustrative purposes only, and in on way should be construed to limit the scope of the invention.

In FIG. 9, the set top box 900 comprises a processor 904 which executes various applications programs stored in memory 910. The memory 910 also stores an Indexing Module 911, which is software executed by the processor allowing the set top box to receive and process input from the user. In one embodiment, the processor stores this information and memory and then provides this information back to the cable service provider via a reverse communications channel 905. In other embodiments, the processor creates the index file and stores in memory 910. The user inputs are received from a handheld remote controller 915, which communicates via a wireless interface 914 with the processor 904.

The set top box may comprise disk storage 912 or other forms of non-volatile memory, including ROM, flash memory, etc. This disk storage may data and programs as required, including a copy of the indexing module. The set top box also typically comprises various digital-to-analog controllers 916 and 922 that are processed by amplifiers 918 and 924 to generate the appropriate video and audible signals in digital or analog form for an external video display 920 and speaker 926 (these are typically part of the television connected to the set top box, and not part of the set top box). At certain times, menus for selecting the target program or index file may be produced on the user's television set in conjunction with operating the service. The set top box may also have an external input interface 928 for receiving input, such as from a text keyboard, mouse, or other such device, with which the user can use to select menu options or provide text input.

The set top box also comprises a power supply 908 for powering the components as needed. The tuner 902 is used to tune to a particular channel, which is used when viewing the VOD target program. The carousel data interface 906 allows the cable service provider to load the indexing module onto the set top box as required.

### IPTV Considerations

The present invention may be embodied using a set top box connected to a HFC distribution network, accessing a VOD service. In other embodiments, the video service provider may provide cable services using the Internet as the delivery medium. In this case, cable distribution plant may still be an HFC network, but one that is providing video programming and associated services using an IP based transport and signaling infrastructure. It is possible that set top boxes may still be used, but typically the viewing user (as well as the creating user) will use a personal computer as the viewing device. The video program may be streamed to the user's personal computer with the service provider excising the content segments, or the video program may be streamed and stored on the user's personal computer where the index file is also stored and applied when viewing the video program. In these various embodiments, it still remains the case that an index file is created, identified, and used when viewing a video program, so that a customized viewing experience can occur by the viewing user.

### User Viewing Devices

The present invention has been largely illustrated using a set top box connected to a cable service provider, where the set top box then interfaces with a television set. However, other embodiments of the present invention are not limited to the video service provider being a cable service provider, and the user's viewing device comprising a set top box/television set. Other embodiments may involve satellite based video services providers, wireless communication providers, such as WiFi or WiMax based Internet providers, as well as cellular (e.g., 3G or 4G) data communication providers. Other embodiments of the invention may not even incorporate service providers, but may be manifested using stand alone devices, such as portable video players. Thus, for example, a portable video player device may store a target progam, an index file, and apply the index file to the target program to provide the custom viewing experience without relying on a service provider to stream the content to the device.

The above also illustrates that a variety of viewing devices may be used. Intelligent cell phones (e.g., capable of playing video) can be used, as well as various types of personal digital assistants, or notebook type of computers (including, the so-called netbooks). Many of these devices are also based on Internet based protocols, and may represent IPTV viewing type devices.

### Typical Application

A typical application of the indexing on-demand invention can be illustrated using the aforementioned situation of a parent desiring to control the viewing experience of their children. In summary, the parent desires to provide a “G” rated viewing experience for their child. In this illustration, the parent is the index creating viewer (“John Smith”) and creates an index file by selecting the target program using his cable service provider's VOD service. This process is illustrated using various “screen shots” or representative menus presented to the creating user.

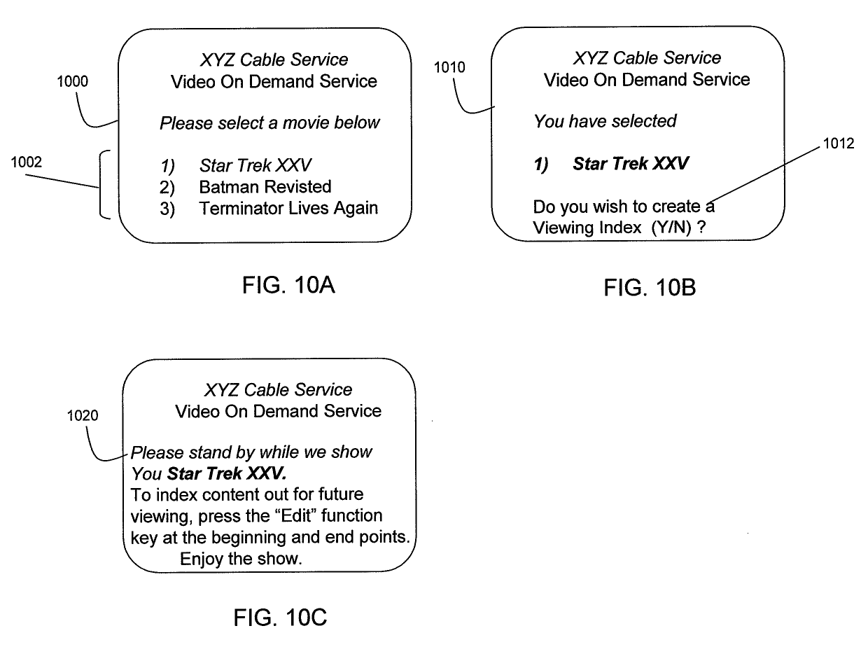

In this example, the initial menu screen 1000 is presented after invoking the VOD service shown in FIG. 10A. The user is presented with instructions to select a movie from a list of movies 1002. The list is simplified to illustrate the principles of the present invention, and more sophisticated selection and searching means can be employed. After selecting the program, the user is then presented in FIG. 10B a screen 1010 confirming the selection, and asking whether the viewer desires to create a viewing index. Assuming the user confirms this, the next screen image is shown in FIG. 10C where the screen image 1020 provides instructions as to how to mark the content segments. The user is then presented with the movie, and marks the segments as appropriate.

After completed, additional images may be presented allowing the user to input title descriptions, comments, or other Metadata that the system will retain. The cable service provider may store the index in a local database, and note in the VOD system that an index file is available for the selected target program.

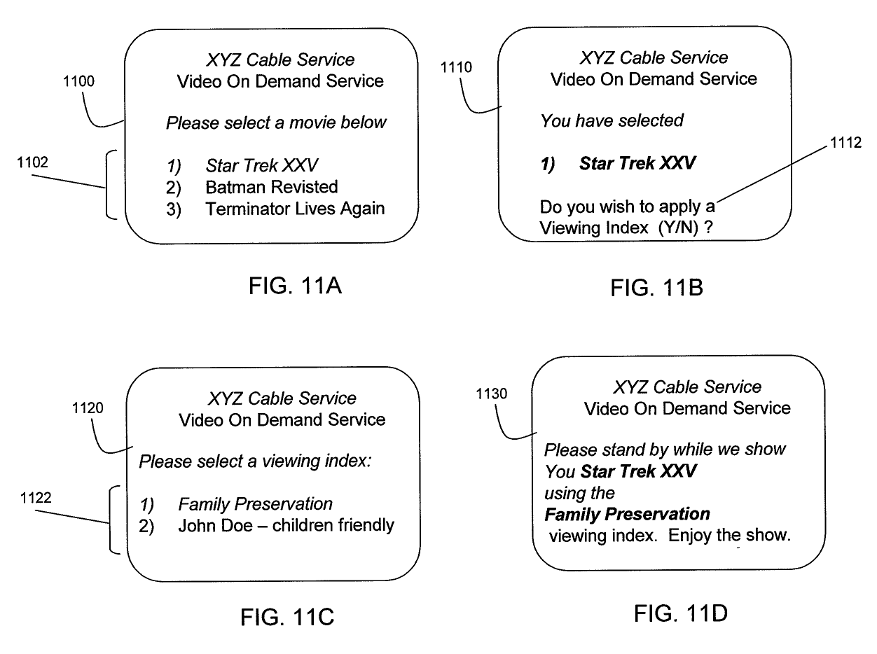

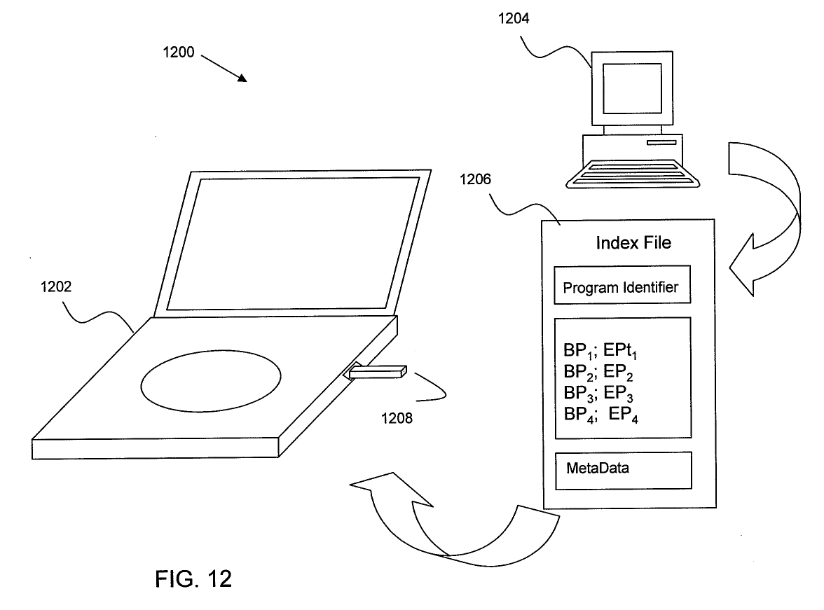

Subsequently, another viewer (“Jane Doe”) desires to allow her children to view the same movie. Jane Doe may know that John Smith has created an index file, and that the index is available for use. Jane may have learned of this via an organizational bulletin board, by accessing a web portal indicating this, by email, etc. Jane Doe accesses the same VOD service and as shown in FIG. 11A, the same screen image 1100 is presented with the same movie titles 1102, and Jane selects the same movie.

In FIG. 11B, the screen image 1110 confirms the selection, and because an index file is now created, the image asks Jane if a viewing image is to be applied in viewing the program. If Jane says no, then the viewing experience is not customized. In this case, Jane indicates “yes”, and the screen image 1120 shown in FIG. 11C is shown.

In FIG. 11C, there are two index files available—one originating from the hypothetical “Family Preservation” Organization, and the other from John Doe, with a comment that the index is “children friendly.” Jane selects the desired index, and the resulting screen image 1130 of FIG. 11D is shown. The viewing experience is then customized by excising the content segments as defined by the index file created by John Doe.

### Other Embodiments

The above embodiments focused on applying the index file to an on-demand video program using a VSP's service. In other words, the user is using a service of selecting an viewing a particular program, without having to maintain a store of video programs.

However, other embodiments of the invention are possible where the viewing user does not use a VSP's on-demand service and does maintain a store of video programs. Specifically, one embodiment applies to where personal video players (PVPs) are used and the user has a library of one or more DVDs. Such portable video players are common, and allow a DVD or other storage medium to be accessed for playing out a movie. Such a configuration is shown in FIG. 12. In other embodiments, a notebook PC with appropriate software could be used.

In FIG. 12, the system 1200 is shown as the aforementioned stand-alone index authoring tool 1204, which the creating user uses to create an index filed 1206. As noted, the index file may be created by other individuals, and the files can be loaded into a web portal, searched and downloaded by viewing users. In this embodiment, a parent using well known Internet tools is able to download the index file from a remote repository using a PC (not shown), and store it into a memory stick 1208, or other non-volatile memory storage medium in order to load it into the PVP 1202. This is one way in which the index file may be loaded into the PVP.

When a DVD is loaded onto the player, and a corresponding index file is present, the DVD play can then play the movie as modified by the index file. The software in the PVP player is modified to allow the loading, erasing, identification, and use of the index file when playing DVDs. These modifications required are consistent with the teachings provided herein in order to provide the customized viewing experience to the viewing user.

Many modifications and other embodiments of the inventions set forth herein will come to mind to one skilled in the art to which these inventions pertain having the benefit of the teachings presented in the preceding descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for providing a subset of a video program to a user comprising:
a cable distribution network interface configured to transmit video over a cable distribution plant;
a memory configured to store an index file, said index file comprising:
a) a video program identifier identifying a video program,
b) a first data point identifying a first location in said video data file,
c) a second data point identifying a second location in said video data file;
a processor configured to receive
a request from said user to view said video program, wherein said video program is stored as said video data file in a data store, wherein said processor is further configured to retrieve said video data file from said data store and said index file from said memory, and said processor is configured to use said index file to provide said subset of said video program to said cable distribution network interface for transmitting said subset of said video program to said user, wherein said subset of said video program comprises said video data file excluding a portion of said video data file defined by said first location and said second location.

2. The system of claim 1 further comprising:
a video on-demand server comprising a second processor and said data store, said second processor configured to receive a second request from said processor for said video data file; said second processor configured to process said request from said user to view said video program.

3. The system of claim 2 further comprising:
an index server comprising computer readable medium storing an index collection module, wherein said index collection module is configured to:
a) receive a first input and a second input, wherein said first input is generated by a second user different from said user, wherein said second user previously requested said video program;
b) generate said first data point and said second data point wherein said first data point corresponds to a first time offset of said video program and said second data point corresponds to a second time offset of said video program, and
c) store said index file in said memory.

4. The system of claim 1 further comprising:
an index server comprising a computer readable medium storing an index application module, wherein said index application module is configured to:
a) retrieve said index file;
b) use said first data point of said index file to determine said first location in said video data file;
c) use said second data point of said index file to determine said second location in said video data file;
d) provide said video data file excluding said portion to said cable distribution network interface, thereby streaming a subset of said program video file to the user.

5. The system of claim 4 further wherein said index server is further configured to stream said subset of said program video file to the user with an advertisement data file inserted therein.

6. The system of claim 4 further comprising:
a video on-demand server configured to receive a request to provide said video program to a second user different from said user;
an index server comprising a computer readable medium storing an index collection module, wherein said index collection module is configured to:
a) receive a first input and a second input, wherein said first input is generated by said second user during viewing of said video program,
b) generate said first data point and said second data point wherein said first data point corresponds to a first time offset of said video program and said second data point corresponds to a second time offset of said video program, and
c) store said index file in said memory.

7. The system of claim 6 wherein said video on-demand server is configured to receive input from said second user, wherein said video on-demand server is configured to use said input to identify said index file prior to said streaming said video program to said second user.

8. A method for providing a subset of a video program to a viewer comprising:
receiving a request at a server in a cable system from said viewer to view the video program;
receiving an indication at the server from said viewer identifying an index file to be processed in conjunction with viewing the video program;
retrieving the index file by the server from memory prior to providing said subset of the video program to the viewer, wherein said index file comprises
a) a video program identifier indentifying the video program, and
b) a content segment, said content segment comprising
a first data point identifying a beginning point of the content segment and
a second data point identifying an ending point of the content segment,
wherein said content segment represents a portion of said video program;
providing said subset of said video program comprising a digital video data file by an index application module, wherein said index application module uses said index file to stream said subset of the video program to a cable headend of the cable system, wherein said subset of the video program comprises said digital video data file excluding said content segment.

9. The method of claim 8 comprising the steps of:
receiving a second request at the server in the cable system from another viewer to view the video program, said second request received prior to said viewer requesting the video program;
providing the video program to the another viewer wherein during streaming of the program to the another viewer, an index collector module receives:
a first input identifying a beginning point of a content segment,
a second input identify the ending point of the content segment;
generating an index file in the server, wherein said index file comprises:
a program identifier identifying the video program,
a first data point corresponding to said beginning point of the content segment,
a second data point corresponding to said ending point of the content segment; and
storing said index file in said memory.

10. The method of claim 9 further comprising the steps of:
receiving, in the cable system from the another viewer after receiving the second request at the server, data identifying the another viewer; and
storing said data in said index file in the memory.

11. The method of claim 8 wherein providing said video program comprises streaming an MPEG digital video file over a cable distribution network wherein said MPEG digital video file represents a series of digital image data of physical objects.

12. The method of claim 8 further comprising the step of:
transmitting data to a set top box associated with said viewer, said data comprising text for displaying on a television connected to said set top box, said data comprising two or more identifiers of two or more index files associated with said video program.

13. A method of processing an index file comprising the steps of:
receiving a request at a server in a cable system from a user to view a video program;
receiving an indication at the server from the user indicating that an index file is to be created;
streaming the video program to said user wherein said user provides during said streaming:
a first input identifying a beginning point of a content segment, and
a second input identifying an ending point of the content segment; and
generating said index file, said index filed comprising
a program identifier identifying said video program,
a first data point identifying said beginning point of the content segment, and
a second data point identifying said ending point of the content segment,
wherein said index file is capable of being used by the cable system to stream a subset of said video program comprising said video program excluding said content segment to a second user, wherein said second user subsequently requests to said server to view said video program.

14. The method of processing an index file of claim 13 further comprising:
receiving text input from said user identifying said user;
receiving rating input from said user identifying a rating associated with said video program; and
storing said text input and said rating input from said user in said index file.

15. The method of processing an index file of claim 13 further comprising:
receiving a request from said second user after said index file is generated to view said video program;
receiving an indication from said second user identifying said index file; and
streaming said video program excluding said content segment to said second user.

16. A computer-readable medium comprising computer-readable program instructions executable by a processor for providing a providing a subset of a video program to a viewer, said computer-readable program instructions adapted to:
receive a video program data file corresponding to said video program from a server storing said video program data file;
receive an indication of an index file to be used in determining which sections of said video program data file to stream to a cable headend multiplexor for said viewer;
read a first data value in the index file, said first data value identifying a beginning point of a content segment;
read a second data value in the index file, said second data value identifying an ending point of the content segment; and
process said video program data file so that said video program data excluding said content segment is streamed to the cable headend multiplexor for said viewer.

17. A computer readable medium of claim 16 further comprising instructions adapted to:
receive a request for said video program from another viewer;
stream a first portion of said video program to said another viewer;
receive a first input from said another viewer during streaming of said video program to said another viewer, said first input identifying said beginning point of the content segment;
receive a second input from said another viewer during streaming of said video program to said another viewer, said second input identifying said ending point of the content segment;
generate said index file, wherein said index file stores said first data value, said second data value, and said program identifier; and
store said index file in a memory.

18. The computer readable medium of claim 17 further comprising instructions adapted to:
receive text data originating from said viewer, said text data associated with said index for said video program; and
storing said text data in the index file in the memory.

19. The computer readable medium of claim 16 further comprising instructions adapted to:
read a third data value in the index file, said third data value identifying a beginning point of a second content segment;
read a fourth data value in the index file, said fourth data value identifying an ending point of the second content segment; and
process said video program data file so that said video program data further excluding said second content segment is streamed to the cable headend multiplexor for said viewer.

20. A computer-readable medium comprising computer-readable program instructions executable by a processor, said computer-readable program instructions adapted to:
receive a request for a video program at a cable headend from a viewer requesting on a cable system;
stream a first portion of said video program to said viewer from the cable system to the viewer;
receive a first input from said viewer during streaming of said video program;
determine a first data value corresponding to a beginning point of a content segment, wherein said first data value defines a time offset from the beginning of said video program;
receive a second input from said viewer during streaming of said video program;
determine a second data value corresponding to an ending point of the content segment;
generate an index file associated with said video program, wherein said index file stores said first data value, said second data value, and a program identifier of the video program; and
store said index file in a memory in the cable system, wherein said index file can be used by another viewer requesting to view said video program on the cable system.
